(19) United States
(12) Patent Application Publication
(10) Pub. No.: US 2011/0059211 A1
(43) Pub. Date: Mar. 10, 2011

(54) Apparatus and method with individual preparation and hybrid heating for making generally flat dough based products

(76) Inventors: Harnek Chandi, Burnaby (CA); Jagtender Barpagga, Burnaby (CA)

(21) Appl. No.: 12/584,467

(22) Filed: Sep. 4, 2009

(51) Int. Cl. A21D 8/06; A23P 1/00; A21D 8/02; A21B 1/48; A21B 2/00; A47J 37/00

(52) U.S. Cl. 426/243; 426/502; 99/443 C; 392/416; 99/353

(57) ABSTRACT

An apparatus for making generally flat dough based products includes a supply station having at least two hoppers for holding different ingredients and respective valve mechanisms disposed below outlets of the hoppers and being operable to control the quantities of ingredients separately dispensed from the hoppers, a mixing bowl disposed below the hoppers in a position to receive the different ingredients in the predetermined quantities wherein the mixing bowl is adapted to open for releasing a dough based product prepared therein toward a conveyor, and a heating station having first and second heating zones arranged along the conveyor between entry and exit ends thereof and being operable to produce infra-red and electric resistance heating respectively in the first and second heating zones so as to cap and cook the prepared dough based product by the time the product is moved by the conveyor to its exit end.

### FIELD

The field of invention generally relates to dough based food preparation and is, more particularly, concerned with an apparatus and method with individual preparation and hybrid heating for making generally flat dough based products.

### BACKGROUND

In order to more clearly describe the type of cooking methods existing in the prior art, the cooking of chapatis will be taken as an example.

Chapatis are wheat flour based bread products usually consumed on a daily basis in households of predominantly Indian and Pakistani origin. Chapatis are also referred to as rotis or phulkas and are also made in other variations based on their size, thickness and ingredients. Examples of these variations are puri, paratha, naan, tandoori roti etc, and usually depend on the region of origin. While chapatis are a traditional food product in several South Asian countries, they are becoming more and more popular in countries outside of Asia.

A chapati is basically an unleavened, disc-shaped cooked wheat bread. The moisture content of the uncooked dough used to make a chapati usually ranges from 35 to 52% by weight. The dimensions of chapatis vary from one region to the other, but are usually between 6 to 22 cm in diameter, and 1 to 5 mm in thickness. The weight of a chapati is generally from 15 to 40 grams per piece depending upon the size, thickness and ingredients.

In devices currently available in the market, dough is rolled out into thin discs and placed on a griddle. During the cooking process, the temperature range of the griddle is typically in the range 125° to 210° C., depending on the type of flour used. When the flattened dough for a chapati is placed into thermal contact with the griddle, a thin vapor-impervious film or capping layer from 0.05 to 0.1 millimeters thick develops on the side of the chapati that is in contact with the griddle. This capping layer substantially seals the side it is on against vapor exhaustion from the interior of the chapati. Usually the time needed to produce such a capping layer depends upon both the moisture content of the dough and on the cooking temperature of the griddle, and generally ranges from about 10 to 40 seconds.

The same process is repeated for forming a capping layer on the other side. A chapati is considered cooked once the flattened dough has inflated, or puffed out, into a roughly oblate spheroid shape. The degree of puffing determines the quality of the cooked chapati. After removal from the heat, the puffed chapati relaxes back to a flat shape. The capping layers are useful in retaining the proper moisture content, which, in the cooked product should be about 5-8% by weight. Without the appropriate moisture content in the cooked chapati, the end product will be stiff and hard in structure and, as a result, unappetizing. Retention of moisture, as generally indicated by the degree of puffing, is therefore very important in chapati making.

The productivity of the above methods depends on the number of chapatis that can be placed on the griddle at any given time. Also, much of the process is manual, even when using available devices to assist in the process.

Examples of devices currently available to assist in parts of the food production process, include, for example, automated mixing devices, flattening devices, shaping devices and cooking devices. These devices can improve productivity and simplify the production process of flat dough breads such as chapatis and tortillas.

As an example of such a device, U.S. Pat. No. 4,806,090 discloses an apparatus for manufacturing a substantially circular dough product. This apparatus comprises a turntable defining a planar surface and a conical roller adapted to cooperate with the turntable. The apparatus may produce portions of flattened dough with a consistent thickness and perfect circularity. This apparatus handles only one part of the chapati making process, and lacks components to knead the dough and cook the chapatis.

Another example of such a device is detailed in U.S. Pat. No. 5,630,358, entitled “Countertop appliance for making disc-shaped edibles”. This appliance includes a dough maker, carousel, shaper, conveyor, heating assembly and programming module to prepare and cook flattened dough products. Use of the appliance requires that a user load the mixing bowl of the dough maker manually with the desired ingredients. A user may, however, not precisely calculate and load the correct quantities of ingredients for the desired output.

U.S. Pat. No. 5,567,459 discloses a method for cooking corn dough tortillas using infrared radiation. Cooking is effected with a considerably reduced cooking time by applying infrared radiation simultaneously on both sides of the food product.

Existing devices are typically large and often have many moving parts that need cleaning after each use. Excessive time spent on cleaning and maintaining hygienic conditions for a device often do not justify the usefulness of the device.

Once the dough is made, existing devices will generally continue making product until all the dough is consumed, which may be inconvenient. If enough products have been cooked then the device may be left containing dough that may not be used later on, and may go to waste.

Existing devices do not offer features that retain the moisture in the products throughout the whole cooking cycle. Products cooked using such devices need to be consumed immediately and cannot be stored for handling or later use due to too low a moisture content leading to hardness.

### SUMMARY

The disclosed subject matter of the present invention relates to an apparatus and method with individual preparation and hybrid heating for making generally flat dough based products. The hybrid heating aspect of the apparatus is its ability to retain moisture while cooking dough based products, such as chapatis, parathas, naan breads, tortillas, crepes or other bread products. The individual preparation aspect of the apparatus allows the number of bread products to be predetermined and thus the apparatus to only mix the required amount of dough for making the predetermined number.

An advantage of the apparatus disclosed herein is that, although not necessarily so limited, it may be automated to enable a reduced amount of work to be provided by the user. This eliminates the need for several pieces of equipment and eliminates manual mixing, kneading and flattening of the dough. A further advantage is its facility to automatically select and mix ingredients in the appropriate portions for making just enough dough to make a single or individual chapati or other bread product. As the apparatus can make dough for one chapati at a time, the number of chapatis desired can be programmed. Excess dough is not made, which facilitates the cleaning process and reduces waste. Another advantage is that it can be programmed for various parameters including thickness, type and size of the product. Day and time of day can be also be included as a programmable parameter so that the apparatus can automatically start making product in advance of it being required. Still another advantage is that it can allow for a variety of tastes by providing a means for butter or oil to be sprayed on the finished product.

Accordingly, in an aspect of the present invention, an apparatus for making generally flat dough based products includes a supply station having at least two hoppers for holding different ingredients and respective valve mechanisms disposed below bottom outlets of the hoppers and being operable to control the quantities of ingredients separately dispensed from the hoppers that can be used to prepare a dough based product, a mixing bowl disposed below the hoppers in a position to receive the different ingredients dispensed from the hoppers in predetermined and repeatable quantities wherein the mixing bowl is adapted to open for releasing a prepared dough based product therefrom, an actuator adapted to mix and shape the ingredients in the mixing bowl so as to provide the prepared dough based product therein, a conveyor having an exit end and an entry end spaced from the exit and disposed below the mixing bowl to receive the prepared dough based product at the entry end and to move the prepared dough based product toward the exit end, and a heating station arranged along the conveyor between the entry and exit ends thereof and being operable to produce heating of the prepared dough based product so as to cap and cook the prepared dough based product by the time the product reaches the exit end of the conveyor.

In another aspect of the present invention, an apparatus for making generally flat dough based products includes a supply station for holding different ingredients and being operable to dispense the ingredients in predetermined and repeatable quantities that can be used to prepare a dough based product, a mixing bowl disposed below the supply receptacle in a position to receive the different ingredients in the predetermined quantities wherein the mixing bowl is adapted to open for releasing a prepared dough based product therefrom, a first actuator adapted to mix and shape the ingredients in the mixing bowl so as to provide a prepared dough based product therein, a conveyor having an exit end and an entry end spaced from the exit and disposed below the mixing bowl to receive the prepared dough based product at the entry end and to move the prepared dough based product toward the exit end, and a heating station including first and second heating zones arranged along the conveyor between the entry and exit ends thereof and being operable to produce IR and electric resistance heating respectively in the first and second heating zones so as to cap and cook the prepared dough based product by the time the product reaches the exit end of the conveyor.

In still another aspect of the present invention, a method for making generally flat dough based products includes automatically dispensing different ingredients separately into a mixing bowl in predetermined quantities, mixing and the different ingredients in the mixing bowl so as to provide a dough mass, shaping the dough mass to form a prepared dough based product, heating the prepared dough based product in a first heating zone so as to cap the prepared dough based product, and heating the prepared dough based product in a second heating zone so as to cook the prepared dough based product.

Other features and advantages of the present invention will become apparent from the following more detailed description, taken in conjunction with the accompanying drawings, which illustrate, by way of example, the principles of the invention. It is not intended to limit the invention by the different configurations that have been shown, described and summarized, except to the extent that is indicated by the appended claims.

### BRIEF DESCRIPTION OF THE DRAWINGS

The novel features that are considered characteristic of the present invention are set forth with particularity in the appended claims. The invention itself, however, both as to its organization and its method of operation, together with advantages thereof, will best be understood from the following description of specific embodiments when read in connection with the accompanying drawings.

FIG. 1 is a simplified schematic diagram showing the features of an exemplary embodiment of the apparatus of the present invention for making generally flat dough based products.

FIGS. 2A and 2B when placed together at the dot-dashed line, together provide a schematic representation of an exemplary embodiment of an apparatus of the present invention showing its various elements and their interrelationships for making generally flat dough based products.

FIG. 3 is a flow chart showing the steps of a method of the present invention for making generally flat dough based products as performed by the apparatus.

### DETAILED DESCRIPTION

The disclosed apparatus is an automated appliance designed to select, mix, flatten, shape and cook dough in order to conveniently produce soft chapatis, tortillas, crepes and other dough products with characteristics selected by the user. It may be configured as a countertop appliance.

Although the method and apparatus of the present invention may be used for making any type of food products, it is described herein with particular reference to making chapatis. Therefore, the detailed description of certain embodiments of the disclosed apparatus and method may mainly refer to making chapatis, although it must be clearly understood that the method and apparatus of the present invention can be equally used for making other types of dough based food products. For other dough products to be made, the overall process will generally be the same, but parameters such as the ingredients, and speed and energy required in the cooking process may be different.

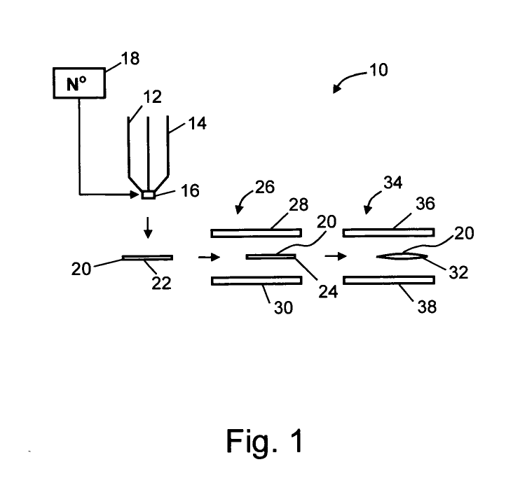

Referring to FIG. 1, there is illustrated a simplified schematic diagram of an apparatus in accordance with the present invention, being generally designated 10. The apparatus 10 includes at least two container-like hoppers 12, 14 to hold unmixed ingredients. In a basic example, the unmixed ingredients could be water and flour. Ingredients can be released from the base of the hoppers 12, 14 into a suitable station 16, under the control of a controller 18, to prepare a single or individual mixed dough based product with ingredients of proper proportion and quantity. The controller 18 may be programmed to cause the station 16 to automatically let through enough ingredients for making a single, roughly ball-shaped, mass of dough (not yet shown), or may be programmed to let through a timed or triggered series of quantities of ingredients for making a series of such dough masses. The ingredients for each single dough mass are mixed, kneaded and then flattened into a generally flat, or disc-shaped, dough mass 20. The flat dough mass 20 is then fed to an entry position 22 and therefrom into a capping position 24 through a first heating zone 26 defined between, for example, first upper and lower infra-red (IR) heaters 28, 30. The main function of the first upper and lower IR heaters 28, 30 of the first heating zone 26 is to rapidly form capping layers on the dough mass 20 by the time it reaches an exit end of the first heating zone 26. The capped dough 20 mass then passes into a puffing position 32 through a second heating zone 34 defined between, for example, second upper and lower electric resistance heaters 36, 38. As the capped dough mass 20 passes through the second heating zone 34 it cooks further, more slowly, while retaining moisture and puffing out.

The apparatus 10 can be configured, by programming the controller 18, to cook a predetermined number of chapatis. For example, it may be configured to accept an input specifying the number of chapatis to be made. It also can be configured to concurrently cook multiple chapatis each at a different stage in the cooking process. In the example shown, there are three chapatis being prepared concurrently, in entry, capping and puffing positions 22, 24 and 32. The controller 18 allows the user to control the quantity, size, thickness and the cooking time of the product, either to be prepared immediately or at a later, scheduled time and/or date.

As will be pointed out below, more than the two individual hoppers 12, 14 illustrated in FIG. 1 can be included in the apparatus 10 to hold, in addition to water and flour, other additives such as herbs and/or spices in individual container-like hoppers. Still more hoppers can be attached to add other additives, grains and other ingredients if required.

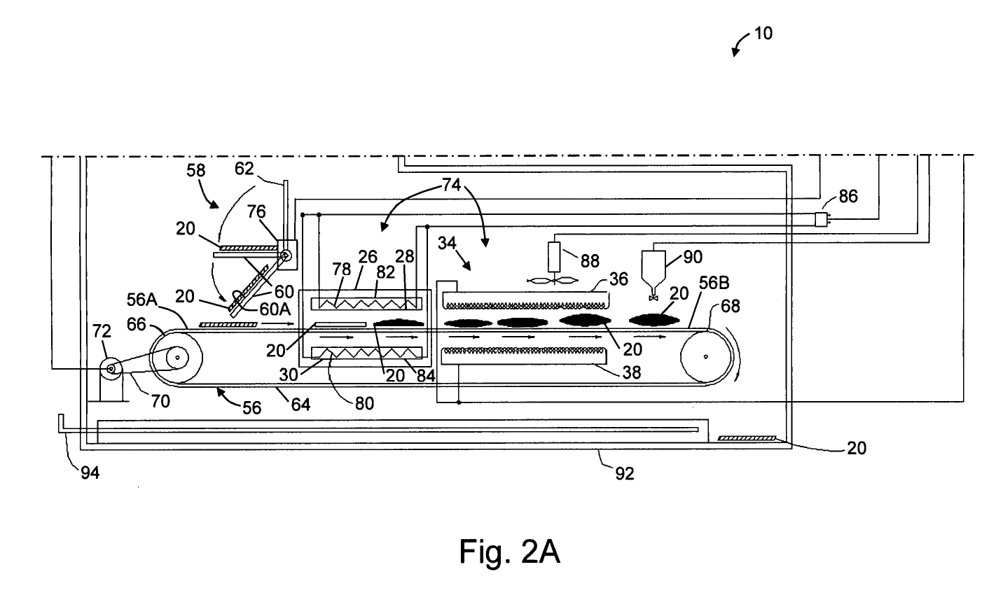

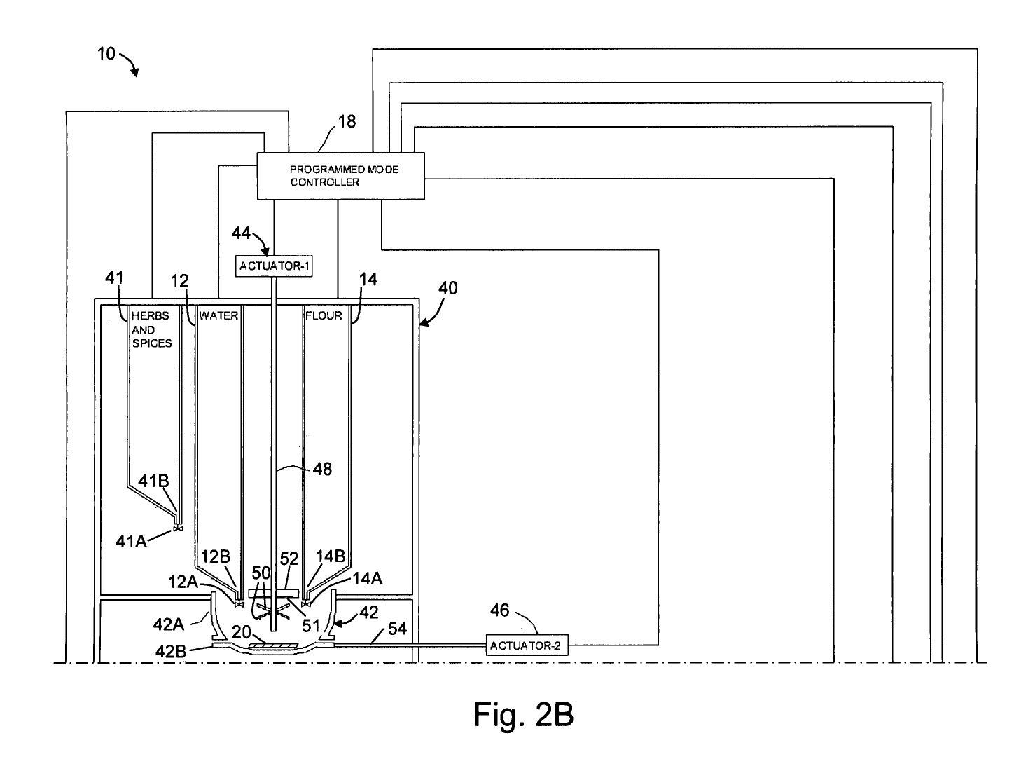

Turning now to FIGS. 2A and 2B, together there is illustrated a more detailed schematic representation of an exemplary embodiment of the apparatus 10 in accordance with the present invention for making chapatis, rotis, tortillas, crepes, puris and other disc-shaped dough products in accordance with the method of the present invention described in detail later. The apparatus 10 is configured, as briefly described earlier and in greater detail hereafter, to operate in an automated manner, quickly turning raw ingredients into a cooked edible product. The apparatus 10 can also be made compact enough so that it can be stored on a countertop or shelf, thereby making it ideal for both household and commercial use.

The apparatus 10 includes a supply station 40 which, in addition to having the two above-mentioned hoppers 12, 14 for holding water and flower respectively, has a third container-like hopper 41 that holds herbs/spices. The hopper 41 in conjunction with the hoppers 12, 14 can also be used to add additives such as milk, salt, a pinch of sugar, oil or grains. The hoppers 12, 14, 41 can be made of stainless steel, and may optionally include a glass window for viewing the level of ingredients. Also, the supply station 40 also has valve or trapdoor mechanisms 12A, 14A, 41A below bottom outlets 12B, 14B, 41B of the hoppers 12, 14, 41 to control the quantities of ingredients to be dispensed therefrom due to gravity. The quantities of ingredients may be substantially repeated in approximately the same predetermined quantities for making a series of dough based products.

The apparatus 10 also includes a detachable mixing bowl 42 in which to make dough and first and second actuators 44, 46 adapted to coact in conjunction with the mixing bowl 42 for enabling formation and manipulation of the dough mass 20 therein and its discharge from the mixing bowl 42 once completed. The mixing bowl 42 has a stationarily positionable upper main portion 42A and a removable or displaceable lower or bottom portion 42B. The mixing bowl may be sized appropriately for accommodating a dough mass suitable for making a single chapati or other dough based product. The first and second actuators 44, 46 preferably are conventional linear and rotary electromechanical types. The first actuator 44 includes an actuator control rod assembly 48, and blades 50 and blade plate 52 operatively mounted on a lower portion of the control rod assembly 48. The first actuator 44 controls operation of both the blades 50 and blade plate 52 via the control rod assembly 48. The blade plate 52 has grooves or slots 51 into which the blades 50, after rotation by any necessary angle, will fit and mesh by moving the blade plate 52 down relative to the blades 50 and into the mixing bowl 42. Such meshing of the blades 50 with the blade plate 52 thereby provides a composite disc plate with an effectively flat surface to press the dough downward to make the dough mass 20 in the bowl 42. The second actuator 46 includes an actuator control rod assembly 54 supporting on its outer end the displaceable bottom portion 42B of the mixing bowl 42. The second actuator 46 is operable to displace the bottom portion 42B relative to the stationary upper main portion 42A of the mixing bowl 42 in order to discharge the dough mass 20 downward therefrom. When the blade plate 52 is engaged with the blades 50, the composite disc plate may optionally be operated to further press or flatten the dough mass 20 and also to assist in its discharge from the mixing bowl 42.

The apparatus 10 further includes a conveyor 56 having an entry end 56A vertically spaced below the mixing bowl 42 and a transfer station 58 including lower and upper pressure plates 60, 62 pivotally mounted and vertically spaced below the mixing bowl 42 and above the entry end 56A of the conveyor 56. The mixing bowl 42, the pressure plates 60, 62 and the entry end 56A of the conveyor 56 may be spaced apart by different amounts in different configurations of the apparatus 10. Note that in alternate configurations, the alignment of one or more of the mixing bowl 42, the pressure plates 60, 62 and the entry end 56A of the conveyor 56 may be aligned obliquely, or off-vertical, with respect to each other, while still generally being positioned in the same height order. The pressure plates 60, 62 of the transfer station 58 are adapted to be pivotally moved between successive angularly displaced positions for receiving therebetween the dough mass 20 discharged and dropped from the mixing bowl 42, then further flattening the dough mass 20 therebetween, and finally transferring the flattened dough mass 20 onto the entry end 56A of the conveyor 56. In one exemplary embodiment, the conveyor 56 includes a continuous belt 64 which extends and is movably supported by and between spaced apart drive and idler rolls 66, 68 and drivingly coupled via a drive belt 70 to a drive motor 72. Selective operation of the drive motor 72 will cause rotation of the drive roll 66 and thus cause the belt 64 to move about an endless path in the direction of the arrows and therewith move the flattened or disc-shaped dough mass 20 resting thereon from the entry position 22 through the capping and puffing positions 24, 32 of the aforementioned first and second heating zones 26, 34 of the apparatus 10.

The apparatus 10 further includes a heating station 74 which encompasses the first and second heating zones 26, 34. The first heating zone 26 has the first upper and lower heaters 28, 30 providing infra-red radiation heating for capping the dough mass 20. The second heating zone 34 has the second upper and lower heaters 36, 38 providing electrical resistance heating for puffing the dough mass 20. As also mentioned earlier, the apparatus 10 employs controller 18 for programming the desired operational configuration of the apparatus 10 including the desired ingredients in appropriate quantities that is to be dispensed for making each dough mass 20.

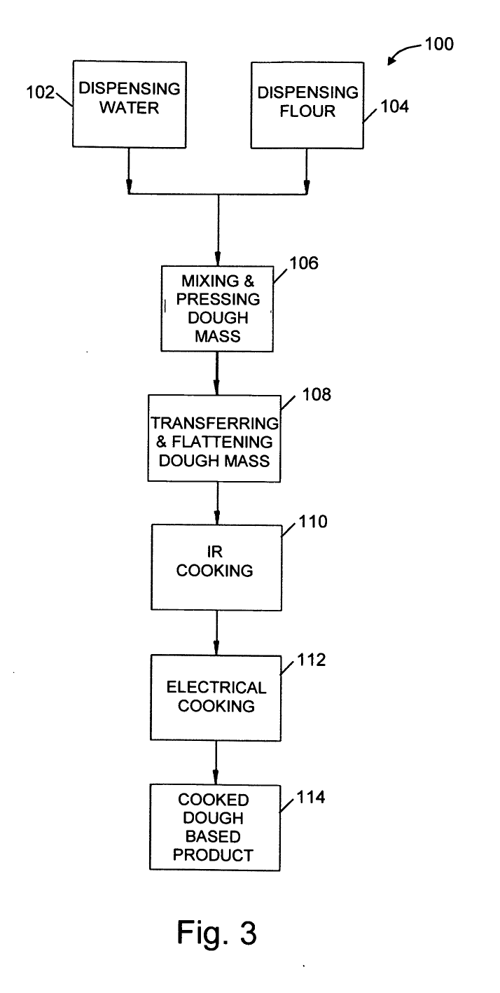

Referring to now FIG. 3, there is illustrated a flow chart 100 showing the basic steps of the method of the present invention for cooking bread products as performed by the above-described apparatus 10. The controller 18 is used to control the operational sequence of the various components of the apparatus 10 in order to ensure that a logical sequence of events occurs in a controlled manner during the production of chapatis and other disc-shaped bread products. The controller 18 may also be used to control the quantity, size, thickness and cooking time of the bread products on an on-demand or scheduled basis.

As per blocks 102, 104, captioned “DISPENSING WATER” and “DISPENSING FLOUR”, the controller 18 initiates the cooking method through controlling the operation of the valves or trapdoor mechanisms 12A, 14A, 41A of the supply station 40 to allow selected amounts of ingredients, water, flour, etc., to feed, by releasing and dropping due to gravity, from the corresponding bottom outlets 12B, 14B, 41B of the hoppers 12, 14, 41 into the mixing bowl 42 for making a single dough mass 20. As per block 106, captioned “MIXING & PRESSING DOUGH MASS”, the controller 18 next controls the operation of the first actuator 44 to move the blades 50 downward into the mixing bowl 42 and rotate the blades 50 to initiate mixing of the water, flour and the other ingredients in the bowl 42 and kneading of the same into the single dough mass 20, which may or may not be ball-shaped. Once all the ingredients are thoroughly mixed and kneaded and the dough mass 20 is thus ready, such being known by the mixing occurring over a preset period of time, the controller 18 next further controls the operation of the first actuator 44 to move the blade plate 52 downward into the meshed relationship with the blades 50. This produces the composite configuration of the disc plate 52 that the controller 18 uses to initiate pressing the dough downward to make the single dough mass 20 more disc-shaped within the bowl 42.

As per block 108, captioned “TRANSFERRING & FLATTENING DOUGH MASS”, the controller 18 then controls the operation of the second actuator 46 and the transfer station 58 to initiate transferring the disc-shaped dough mass 20 from the mixing bowl 42 to the conveyor 56. The transfer is initiated by the dough mass 20 being dropped downward from the mixing bowl 42 to the transfer station 58 where it is further flattened concurrently as it is being transferred to the conveyor 56. More particularly, appropriate force is applied by the second actuator 46 to remove the lower portion 42B of the mixing bowl 42 such that the dough mass 20 falls on an upper non-stick support surface 60A of the lower pressure plate 60 of the transfer mechanism 58. The upper non-stick pressure plate 62 of the transfer station 58, which may be hinged to the lower pressure plate 60, is then rotated downward by a third actuator 76 controlled by the controller 18 to engage on the top of the dough mass 20, pressing it against the upper surface 60A of the lower or base plate 60, thereby further flattening the dough mass 20 between the two plates 60, 62. In an alternate embodiment, the dough could be shaped and flattened with a roller assembly instead of the upper and lower pressure plates 60, 62. The pressure plates 60, 62 may alternately have detachable stainless steel cover surfaces. After the dough mass 20 is flattened, the controller 18 causes the third actuator 76 to initiate downward tilting of the lower pressure plate 62 to enable the flattened dough mass 20 to slide off the lower pressure plate 62 and land in the entry position 22 on the entry end 56A of the conveyor 56.

As per next successive blocks 110 and 112, captioned “IR COOKING” and “ELECTRICAL COOKING” respectively, the controller 18 controls the conveyor drive motor 72 and the first and second heaters 28, 30 and 36, 38 of the first and second heating zones 26, 34 to successively cook the disc-shaped dough mass 20 in a prescribed manner as the conveyor 56 moves the dough mass through the successive first and second heating zones 26, 34 of the heating station 74. The dough mass 20 is cooked in a hybrid manner of heating wherein the first upper and lower heaters 28, 30 employ infra-red radiation to partially cook the dough mass 20 as it advances through the first heating zone 26 and then the second upper and lower heaters 36, 38 employ electric resistance heating to complete cooking of the dough mass 20 as it advances through the second heating zone 34. After the cooking process is completed as per block 114, captioned “COOKED DOUGH BASED PRODUCT”, the cooked dough mass 20 is placed in a cooked chapati receptacle (not shown). Thus, the chapatis are partially baked on the conveyor 56 in the first infra-red heating zone 26 until capping layers are developed and then baked to completion in the second electrical heating zone 34.

More specifically, the conveyor 56 acts as a griddle to support the uncooked chapati as it moves between the infra-red heaters 28, 30 of the first heating zone 26, which comprises the first part of the overall cooking zone. The infra-red heaters 28, 30 located above and below the conveyor belt 64 dry the top and bottom of the flattened dough mass 20 to develop the capping layers. Ideally, capping layers should be formed rapidly in order to best retain moisture. Uncooked chapatis or other flattened dough products generally develop the capping layers within 10 to 40 seconds, depending on the temperature that the dough is subjected to.

The infra-red heaters 28, 30 may each comprise infra-red emitters 78, 80 and optical systems 82, 84 in the form of one or more infra-red reflectors. Both infrared emitters 78, 80 and optical systems 82, 84 are arranged so as to direct the infrared radiation substantially homogeneously onto the surface of the chapati. Infrared radiation is predominantly radiated perpendicularly to the upper and lower surfaces of the chapati to be cooked. The conveyor belt 64 may be transparent to the infrared radiation, or otherwise allow infrared radiation to pass through, and should be capable of withstanding the cooking temperatures of the chapati. An auxiliary controller 86 is connected between and to the controller 18 and the infra-red heaters 28, 30 for regulating the temperature of emission of the infrared radiation.

The infrared radiation may be generated by means of an arrangement of resistive elements connected to a source of electrical power. The power of the infrared radiation emitters is selected in accordance with the weight of the dough, the quantity of moisture to be removed, the desired increase in the temperature and the time duration selected for initial cooking of the chapati. As an example, a preferred emission band for the cooking of a chapati may be from 2.5 to 4.0 micrometers, the density of energy required for the cooking of each chapati may be around 5.5-6.0 W/g and the duration for cooking the chapati about 10-20 seconds.

Infrared heaters typically use an electric current to heat an element. As thermal infrared heat radiation is generally not absorbed by air, infrared heaters can quickly and efficiently warm up objects. Their fast response means that infra red heaters can be switched on or off to match heat requirements. There are other forms of infrared heaters that may be employed, for example, infrared light emitting diodes may be used.

Once capping is developed in the form of small bubbles in the chapati dough, the conveyor 56 moves the dough product into the second heating zone 34 of the heating station 74 to make the chapati puff and/or impart a desired softness to it. The conveyor 56 may be constructed of stainless metal chain or wire and is designed in such a way to allow the dough product to be exposed to maximum heat exposure, in order to ensure rapid cooking. The second heating zone 34 has upper and lower resistive electric element heaters 36, 38 positioned above and below the conveyor belt 64, so that the chapati is cooked as it moves though the second heating zone 34. The radiative and convective heating in this zone completes the cooking, causing the chapati to puff up with steam. A fan 88 may be added to the second heating zone 34 of the heating assembly 76 to blow hot air around the dough products to accelerate the cooking of the chapatis. Heat barriers may be positioned at or near the entry and exit ends 56A, 56B of the conveyor 56 to form a nearly enclosed thermostatically controlled oven, thereby allowing more efficient cooking of the chapatis. A heat barrier may also be positioned between the two heating zones 26 and 34.

First and second heating elements 28, 30, and 36, 38 may be supplied with alternating current, and may be controlled separately or together. Different amounts of current may be supplied to each of the heater elements.

The time spent in the first or infra-red heating zone 26 may be less than the time spent in the second or electrical resistance heating zone 34. The time in the infra-red heating zone 26 may, for example, be 10-20% of the total time it takes to cook a chapati. Infra-red heating generally provides a quick high temperature heating to produce capping layers. The interior of the dough in a chapati is cooked in the electrical resistance heating zone, which generally takes more time. Physical lengths of the oven zones may be configured according to dwell times desired for the chapatis in each of the zones.

An automatic dispenser 90 that contains butter, clarified butter or oil may be positioned over the conveyor 56 at the exit end 56B thereof. The dispenser 90 has a nozzle for dispensing butter or oil onto the chapati when it moves directly below the dispenser 90. Finally, the chapati is discharged to a receptacle as a completed product.

The above process of automatically making disc-shaped dough based food products such as chapatis can be repeated until all the chapatis are cooked as selected in the initial input to the controller 18, or until the ingredients in one of the hoppers 12, 14, 41 is exhausted.

A feature of the apparatus 10 is that the major areas of the apparatus 10 can concurrently accommodate product being processed at different stages. This has been accomplished in part by processing dough serially in single portions. As a result, a relatively small apparatus can be made that can fit on a countertop in the kitchen or the like and can be used to provide a convenient, continuous production method for households, restaurants and other locations. Another benefit of automatically creating the dough balls (masses 20) in single portions is the elimination of the need for a user to separate the dough manually into appropriately sized dough balls.

Parts of the apparatus 10 may be contained within an enclosure 92. A crumb tray 94 may be included.

Temperatures and speed of the conveyor 56 can be determined by those skilled in the art, and will depend on the desired product and properties of the product. The controller 18 may include a PID (Proportional-Integral-Derivate) controller for controlling the temperature in one or both of the heating zones 26, 34. The speed of the conveyor 56 may be variable, and may change during the cooking process depending on desired taste, desired product or temperature of the heating zones 26, 34.

The radiative frequency band for infra-red radiation can be optimized depending on the infra-red absorption properties of the dough. Power and duration in the infra-red zone can be selected according to taste, and/or according to the size and type of bread product.

The absorption factor of raw dough is substantially independent of temperature. For the purpose of this apparatus, infrared radiation having a wavelength within the range of 2.5 to 4 micrometers is recommended for obtaining sufficient energy absorption by the dough.

An alternate embodiment may incorporate a single heater that can be switched from one mode to another, or one temperature to another. Infra-red heaters have fast responses compared to more conventional electrical resistance heaters, and so can be rapidly switched from one mode to another. The conveyor may be configured to stop and start, or change its speed during the cooking process. The fan 88 may also be switched on or off, or have its speed adjusted during the cooking process. A pre-heater may optionally be incorporated to heat the chapati when being pressed, for example. Two infra-red heaters with different settings may be used to achieve the same result.

The primary power source may be a combustible substance, such as liquefied petroleum gas (LPG), diesel, propane, butane, ethanol, or another substance. This energy source may be used to power the two different heating zones directly, in which case they will be non-electrical heaters, or it may be used in a generator to provide electricity which in turn is used to drive electrically powered heating zones. A battery may be used for the control and operation of the actuators. Solar energy may be converted to electricity in photovoltaic cells and used to power the apparatus.

The process and method described above has at least as many variations as there are recipes for dough based flat food products. While the invention has been described with reference to a preferred embodiment, it is to be clearly understood by those skilled in the art that the invention is not limited thereto. Rather, the scope of the invention is to be interpreted only in conjunction with the appended claims.

What is claimed is:

1. An apparatus for making generally flat dough based products, comprising:
a supply station having at least two hoppers for holding different ingredients and respective valve mechanisms disposed below bottom outlets of said hoppers and being operable to control predetermined quantities of ingredients separately dispensed from said hoppers that can be used to prepare a dough based product;
a mixing bowl disposed below said hoppers in a position to receive the different ingredients dispensed from said hoppers in the predetermined quantities, said mixing bowl being adapted to open for releasing a prepared dough based product therefrom;
an actuator adapted to mix and shape the ingredients in said mixing bowl so as to provide the prepared dough based product therein;
a conveyor having an exit end and an entry end spaced from said exit and disposed below said mixing bowl to receive the prepared dough based product at said entry end and to move the prepared dough based product toward said exit end; and
a heating station arranged along said conveyor between said entry and exit ends thereof and being operable to produce heating of the prepared dough based product so as to cap and cook the prepared dough based product by the time the product reaches said exit end of said conveyor.

2. The apparatus of claim 1 further comprising a controller operable to control operations of said supply station, said actuator, said conveyor, and said heating station.

3. The apparatus of claim 2 wherein the mixing bowl is sized for making a single dough based product and the controller is configured to:
accept an input specifying a number of dough based products to be made;
control the valve mechanisms such that the quantities of ingredients dispensed are for one of the dough based products;
control the actuator to mix and shape the ingredients to prepare a single dough based product; and
control the valve mechanisms and the actuator the same number of times as the number of dough based products to be made.

4. The apparatus of claim 1 further comprising a transfer station disposed between said mixing bowl and said entry end of said conveyor and being operable to receive and transfer the prepared dough based product from said mixing bowl to said entry end of said conveyor.

5. The apparatus of claim 4 wherein said mixing bowl has an upper stationary portion and a lower displaceable portion normally disposed under said upper stationary portion so as to provide an openable and closable bottom of said mixing bowl.

6. The apparatus of claim 5 further comprising another actuator coupled to said lower displaceable portion of said mixing bowl and being operable to selectively move said lower displaceable portion away from and back under said upper stationary portion of said mixing bowl to temporarily open said mixing bowl and enable the prepared dough based product to drop downward from said mixing bowl toward said transfer station.

7. The apparatus of claim 1 further comprising another actuator coupled to said lower displaceable portion of said mixing bowl and being operable to selectively move said lower displaceable portion away from and back under said upper stationary portion of said mixing bowl to enable the prepared dough based product to drop downward from said mixing bowl toward said entry end of said conveyor.

8. The apparatus of claim 1 wherein said heating station has first and second heating zones arranged along said conveyor between said entry and exit ends thereof and being operable to produce different types of heating in said first and second heating zones so as to cap and cook the prepared dough based product by the time the product reaches said exit end of said conveyor.

9. The apparatus of claim 6 wherein said different types of heating are infra-red radiant heating in said first heating zone and electric resistance heating in said second heating zone.

10. An apparatus for making generally flat dough based products, comprising:
a supply station for holding different ingredients and being operable to dispense the ingredients to prepare a dough based product;
a mixing bowl disposed in a position to receive the different ingredients;
a first actuator adapted to mix the ingredients in said mixing bowl so as to provide a prepared dough based product therein;
a conveyor having an exit end and an entry end spaced from said exit end and disposed to receive the prepared dough based product at said entry end and to move the prepared dough based product toward said exit end; and
a heating station including first and second heating zones arranged along said conveyor between said entry and exit ends thereof and being operable to produce infrared and electric resistance heating respectively in said first and second heating zones so as to cap and cook the prepared dough based product by the time the product reaches said exit end of said conveyor.

11. The apparatus of claim 10 wherein:
the supply station is operable to dispense the ingredients in predetermined quantities;
the mixing bowl is disposed below said supply station, said mixing bowl being adapted to open for releasing a prepared dough based product therefrom;
the first actuator is adapted to shape the ingredients in said mixing bowl; and
the conveyor is disposed below said mixing bowl; said apparatus further comprising a controller operable to control operations of said supply station, said actuator, said conveyor, and said heating station.

12. The apparatus of claim 10 wherein said supply station has at least two hoppers for holding the different ingredients.

13. The apparatus of claim 12 wherein said supply station also has valve mechanisms respectively disposed below outlets of said hoppers and being operable to control the quantities of ingredients separately dispensed from said hoppers.

14. The apparatus of claim 10 further comprising a transfer station disposed between said mixing bowl and said entry end of said conveyor and being operable to receive and transfer the prepared dough based product from said mixing bowl to said entry end of said conveyor.

15. The apparatus of claim 14 wherein said mixing bowl has an upper stationary portion and a lower displaceable portion normally disposed under said upper stationary portion so as to provide an openable and closable bottom of said mixing bowl.

16. The apparatus of claim 15 further comprising another actuator coupled to said lower displaceable portion of said mixing bowl and being operable to selectively move said lower displaceable portion away from and back under said upper stationary portion of said mixing bowl to temporarily open said mixing bowl and enable the prepared dough based product to drop downward from said mixing bowl toward said transfer station.

17. A method for making generally flat dough based products, comprising the steps of:
automatically dispensing different ingredients separately into a mixing bowl in predetermined quantities;
mixing the different ingredients in the mixing bowl so as to provide a dough mass;
shaping the dough mass to form a prepared dough based product;
heating the prepared dough based product in a first heating zone so as to cap the prepared dough based product; and
heating the prepared dough based product in a second heating zone so as to cook the prepared dough based product.

18. The method of claim 17 wherein said heating includes successively heating the dough based product using first infra-red radiation heating and next electric resistance heating.

19. The method of claim 17 further comprising:
storing the different ingredients in separate hoppers from which the different ingredients are separately dispensed into the mixing bowl;
mixing and shaping the different ingredients in the mixing bowl so as to provide the prepared dough based product therein prior to opening the mixing bowl for releasing the prepared dough based product from the mixing bowl;
transferring the released dough based product to a conveyor;
moving the dough based product from an entry end to an exit end of the conveyor; and
heating the dough based product so as to cap and cook the prepared dough based product by the time the product reaches said exit end of said conveyor.

20. The method of claim 17 further comprising:
specifying a number of dough based products to be made; and
performing the dispensing and mixing steps the same number of times as the number of dough based products to be made;
wherein a heating step for a dough based product prepared from a first dough mass is performed concurrently with the mixing step for a second dough mass.
